(19) United States
(12) Patent Application Publication
(10) Pub. No.: US 2004/0193694 A1
(43) Pub. Date: Sep. 30, 2004

(54) Application gateway systems

(76) Inventors: Randy Salo, San Diego, CA (US); Chris van Hamersveld, San Marcos, CA (US); Barry K. Shelton, San Diego, CA (US); Larry Herbinaux, Vista, CA (US); Teddy D. Lindsey, San Diego, CA (US); Lee M. Inness-Brown, Jamul, CA (US); Jeffrey Martyn, San Diego, CA (US)

Correspondence Address: Qualcomm Incorporated, Patents Department, 5775 Morehouse Drive, San Diego, CA, 92121-1714, US

(21) Appl. No.: 10/816,767

(22) Filed: Apr. 1, 2004

Related U.S. Application Data
(63) Continuation of application No. 09/541,173, filed on Apr. 3, 2000.
Application No. 09/541,173 is a continuation-in-part of application No. 09/438,817, filed on Nov. 10, 1999.

(51) Int. Cl. G06F 15/167

(52) U.S. Cl. 709/216

(57) ABSTRACT

A system for permitting a subscriber to access subscriber information from a remote enterprise network in real-time is presented. The system includes a remote access device with browser capabilities for inputting requests to access the subscriber information. The remote access device communicates with an application gateway server, and the application gateway server rapidly and efficiently processes the requests to access the subscriber information and renders the requested subscriber information on the remote access device. The application gateway server includes a navigation module, a rendering module, a session module, a data access module, and an authentication module for efficiently retrieving user/subscriber data, such as mail, contact, or other user specific data and compiling and sending browser specific data to the input device.

This application is a continuation in part of co-pending U.S. patent application Ser. No. 09/438,817, entitled “SECURE REMOTE ACCESS TO ENTERPRISE NETWORKS,” to Randy Salo et al., filed on Nov. 10, 1999.

### BACKGROUND OF THE INVENTION

1. Field of the Invention

This invention generally relates to the field of communications and information network management. More particularly, the present invention relates to a novel system that allows remote end users to rapidly and securely access information from a variety of subscriber devices.

2. Description of Related Art

Recent innovations in wireless communication and computer-related technologies as well as the unprecedented growth of Internet subscribers have provided tremendous opportunities in telecommuting and mobile computing. In fact, corporate entities and enterprises are moving toward providing their workforces with ubiquitous access to networked corporate applications and data, such as, for example, e-mail, address books, appointment calendars, scheduling information, etc.

The problem with providing universal access to proprietary information is one of logistics. For example, it is common for an individual to keep sets of addresses on different devices, such as work addresses on a personal computer used at work, personal addresses on a home computer, and commonly called telephone numbers on a cellular telephone. Problems arise when the individual is at home and wishes to call or fax a work colleague, particularly when the individual does not have access to the work addresses from the home computer or any other available device. Further, different urgent priority items, such as urgent e-mails, may be unavailable to a subscriber for an extended period of time if the subscriber is equipped only with a personal digital assistant (PDA) and a cellular telephone unable to receive e-mail.

Along with the problem of maintaining data in various locations, users frequently have access to different devices, each having different data access abilities and requirements. For example, certain cellular telephones have speed dial or commonly called telephone numbers, but do not have the ability to receive e-mail. Certain cellular telephone handsets have the ability to receive alphanumeric pages, but some cellular service providers do not support this feature while others do. Also, many PDAs do not have the ability to receive over-the-air transmissions, but can synchronize with a database, such as a database associated with a personal computer and/or network. Other PDAs have the ability to receive and edit e-mail messages. Some systems or networks allow a subscriber to download her e-mail headers to a remote device and read some portion or all of the e-mail. After reading the e-mail on the remote device, some systems delete the e-mail while others maintain the e-mail on the system until read or deleted at the home system. Hence the ability for a subscriber to access, maintain, and dynamically utilize information is heavily dependent on the input device employed by the subscriber.

Further, certain organizations limit access to workers having a need to know the information maintained. For example, many corporations control e-mail using a dedicated server having restricted access, including using firewalls and encryption. Access to this information requires making the information available under conditions imposed and maintained by the corporation.

For purposes of this application, a corporation or other entity, public, private, or otherwise, is referred to as an “enterprise.” As used herein, an enterprise represents any entity maintaining or controlling information at a remote location from a subscriber. Examples of enterprise configurations include a secure corporate network, a dedicated server, or a publicly accessible web site network. Other enterprises may be employed which maintain and control certain information as may be appreciated by those of skill in the art.

While certain systems have been employed to provide access to information maintained at an enterprise, none have provided for access by multiple devices including PDAs, cellular telephones, personal computers, laptops, palmtops, Microsoft® Windows CE devices, and so forth. Further, those systems discussed in the literature that provide information access to users employing a limited set of input devices have suffered from accessibility and data latency problems. Accessibility issues involve providing access to the information by only offering access through a corporate Intranet or other internal access scheme. A subscriber wishing to review his or her e-mail on a laptop borrowed from a colleague frequently is denied access to the corporate information. Further, data latency universally inhibits the ability to access data. Users desire a fast response to the information they desire, and information on any device that takes longer than fifteen seconds to load is undesirable.

Additionally, certain enterprises wish to have control over information maintained on their networks, including maintaining password and account information for the enterprise users. It is therefore undesirable for the enterprise to offer sensitive data, such as subscriber information and passwords, to outside parties where the data may be compromised. Security issues, such as corporate firewalls and encryption of data, must in many instances be maintained and controlled by the enterprise rather than a third party.

Certain enterprises also have particular needs and preferences. For example, some corporate enterprises may maintain a network that interfaces with offices in different countries, and depending on the person accessing the information, he or she may have a particular language preference. Certain enterprises also find it highly desirable to have a reconfigurable interface to provide updated graphics, information, and presence to network users. These subscriber interfaces may change rapidly in some industries. A system offering information access should therefore be readily reconfigurable and offer subscriber interfaces structured for the enterprise for use on a variety of input devices.

Such a system should be relatively easy to set up and maintain, and use readily available hardware and software wherever possible. Further, the system should provide for data access tracking and efficient security and authorization.

Systems fully addressing the aforementioned needs of users and enterprises are relatively unknown in the telecommunications, Internet, and mobile computing fields. Inventors currently employed by Wireless Knowledge, the assignee of the present application, have invented a system utilizing a Data Center to provide access to the desired information over a series of laptops. Those applications include U.S. patent application Ser. No. 09/438,817, entitled “SECURE REMOTE ACCESS TO ENTERPRISE NETWORKS,” to Randy Salo et al.; U.S. patent application Ser. No. 09/438,815, entitled “METHOD OF PROVIDING REMOTE ACCESS TO SUBSCRIBER INFORMATION MAINTAINED ON ENTERPRISE NETWORKS,” to Randy Salo et al.; U.S. patent application Ser. No. 09/436,661, entitled “SECURE REMOTE ACCESS TO ENTERPRISE NETWORKS EMPLOYING ENTERPRISE GATEWAY SERVERS,” to Randy Salo et al., U.S. patent application Ser. No. 09/438,819, entitled “DATA CENTER FOR PROVIDING SUBSCRIBER ACCESS TO DATA MAINTAINED ON AN ENTERPRISE NETWORK,” to Randy Salo et al., U.S. patent application Ser. No. 09/438,033, entitled “ENTERPRISE NETWORK ARCHITECTURE,” to Randy Salo et al.; U.S. patent application Ser. No. 09/438,818, entitled “DATA TRANSMISSION ARCHITECTURE FOR SECURE REMOTE ACCESS TO ENTERPRISE,” to Randy Salo et al.; U.S. patent application Ser. No. 09/438,816, entitled “USER INTERFACE FOR USE WITH SECURE REMOTE ACCESS TO ENTERPRISE NETWORKS,” to Randy Salo et al.; and U.S. patent application Ser. No. 09/438,820, entitled “SYSTEM AND METHOD FOR DETERMINING REMOTE ACCESS DEVICE USED TO ACCESS ENTERPRISE NETWORK DATA,” to Randy Salo et al., the entirety of which are incorporated herein by reference.

The Data Center approach can, in certain circumstances, provide unwanted and undesirable latency. Further, some enterprise personnel have expressed concerns about security of transmissions and maintenance of sensitive information at a remote site, such as a Data Center.

It is therefore an object of the current invention to provide a system for offering convenient and efficient access to data, including e-mail, calendar/date book, and addresses. These terms are commonly known in the art, wherein e-mail represents electronic mail deliverable in a recognized format, including attachments and other electronic mail attributes. Calendar/date book data represents dates of meetings, appointments, holidays, or other noteworthy events maintained in a searchable database type format. Addresses represent information associated with contacts, such as the contact's name, title, company, business address, business phone number, business fax number, home address and/or phone number, cellular phone number, e-mail address, and so forth.

It is a further object of this invention to provide for access to the desired information using any of a variety of input devices, including but not limited to a personal computer, a laptop computer, a PDA, a palmtop computer, a cellular telephone, a two-way pager, and a Microsoft® Windows CE device.

It is still a further object of the present invention to provide a system that recognizes the type of device addressing and requesting the information and to provide the information to the device in a proper format in accordance with the preferences of the enterprise transmitting the information.

It is yet another object of the current invention to provide an interconnection between a user of a device and an enterprise such that the interconnection can quickly, reliably, and efficiently transfer information, such as e-mail, calendar, and address data, back and forth between the device and the enterprise.

It is a further object of the current invention to provide a remote enterprise architecture that supports inquiries from and responses to multiple subscribers using various input devices. The remote enterprise architecture should permit rapid access to the information and transmission of the information while simultaneously maintaining firewall, security, and encryption requirements.

It is still a further object of the current invention to provide architectures which are reliable and easy to use from both a software and hardware standpoint, and utilize where possible existing components to minimize system costs.

It is yet a further object of the current system to provide a subscriber interface that is readily reconfigurable by an enterprise maintaining the information. Further, the subscriber interface should preferably provide enterprise data on various input devices and take into account enterprise and subscriber preferences when interfacing with a subscriber.

It is another object of the current invention to provide a business model for supplying users with access to e-mail, calendar, and address information in a multiple input device environment when the desired information is maintained at a remote enterprise.

### SUMMARY OF THE INVENTION

Accordingly, there is herein provided a computer system for providing access to information maintained on an enterprise network.

One aspect of the present invention is directed to an enterprise network comprising a messaging server that stores data related to group messaging and collaboration applications and an application gateway server. The messaging server is connected via a local area network to this application gateway server. The application gateway server transmits and receives data from remote devices associated with the enterprise network, the associated remote devices being coupled to the application gateway server through a variety of network paths.

The application gateway server preferably comprises a navigation module, a rendering module, a session module, a data access module, and an authentication module. The navigation module receives data preferably in the form of a structured URL and seeks data from the other modules, compiles the information, and transforms the information in browser compliant form back to the device. The session module keeps track of information entered by a user during a particular session. The rendering module locates the appropriate screen for the browser used and action desired and passes this to the navigation module. The data access module provides access to mailbox, contacts, or other user specific data maintained at the enterprise and passes the mail, contacts, or other data to the navigation module. The authentication module preferably interacts with the data access module and the data to verify user credentials, and passwords are preferably maintained at the data site. Various firewall configurations are employed to provide secure interaction with the connection to the gateway server, which is typically the Internet.

Other objects, features, and advantages of the present invention will become more apparent from a consideration of the following detailed description and from the accompanying drawings.

### BRIEF DESCRIPTION OF THE DRAWINGS

The accompanying drawings, which are incorporated in and constitute a part of this Specification, illustrate an embodiment of the invention and, together with the description, explain the objects, advantages, and principles of the invention. In the drawings:

FIG. 1 illustrates a conceptual overview of the design of the current system;

FIG. 1A is an alternate conceptual view of the current invention;

FIG. 1B presents the basic elements of a wireless implementation of the network and access facility of FIG. 1A;

FIG. 1C is the front end of the enterprise network and shows the interaction between the wireless system and enterprise network;

FIG. 2A illustrates an embodiment of the enterprise network having a PPTP VPN Server;

FIG. 2B illustrates an embodiment of the enterprise network having an IPSEC Router/Firewall;

FIG. 3 provides a further simplified version of the current inventive system illustrating major components of the access facility and enterprise network;

FIG. 4 is an alternate implementation of the interface between the access facility and the enterprise network;

FIG. 5 illustrates the configuration of the enterprise dedicated server or messaging server;

FIG. 6 is an alternate embodiment of the current system wherein dedicated server employs multiple information sources;

FIG. 7 presents another alternate embodiment of the current system employing a single firewall;

FIG. 8 illustrates another alternate embodiment of the current system using a dual firewall around the enterprise dedicated server or messaging server;

FIG. 9 is an alternative to the dual firewall configuration wherein the access database is behind both firewalls; and

FIG. 10 shows a hardware specific implementation of the current system.

### DETAILED DESCRIPTION OF THE PREFERRED EMBODIMENTS

The following detailed description of the embodiments of the present invention refers to the accompanying drawings that illustrate these. Other embodiments are possible and modifications may be made to the embodiments without departing from the spirit and scope of the invention. Therefore, the following detailed description is not meant to limit the invention. Rather the scope of the invention is defined by the appended claims.

It will be-apparent to one of ordinary skill in the art that an embodiment of the present invention, as described below, may be realized in a variety of implementations, including the software, firmware, and hardware of the entities illustrated in the figures (i.e., remote access device 104, BSC/MSC 106 and IWF 108). The actual software code or control hardware used to implement the present invention is not limiting of the present invention. Thus, the operation and behavior of the present invention will be described without specific reference to the actual software code or hardware components. Such non-specific references are acceptable because it is clearly understood that a person of ordinary skill in the art would be able to design software and control hardware to implement the embodiment of the present invention based on the description herein.

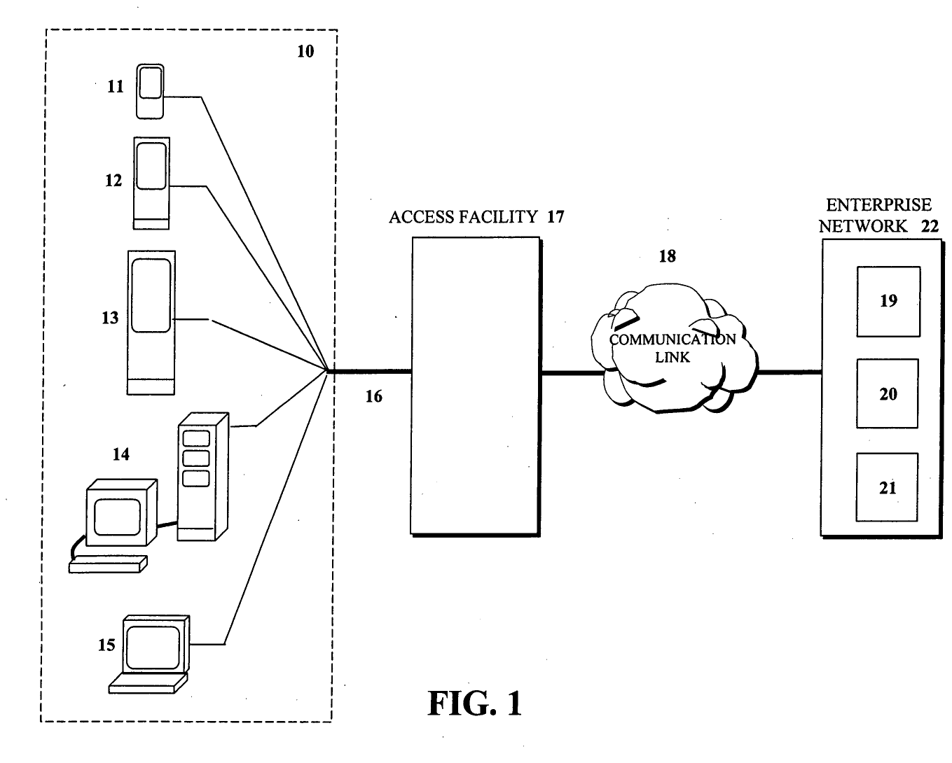

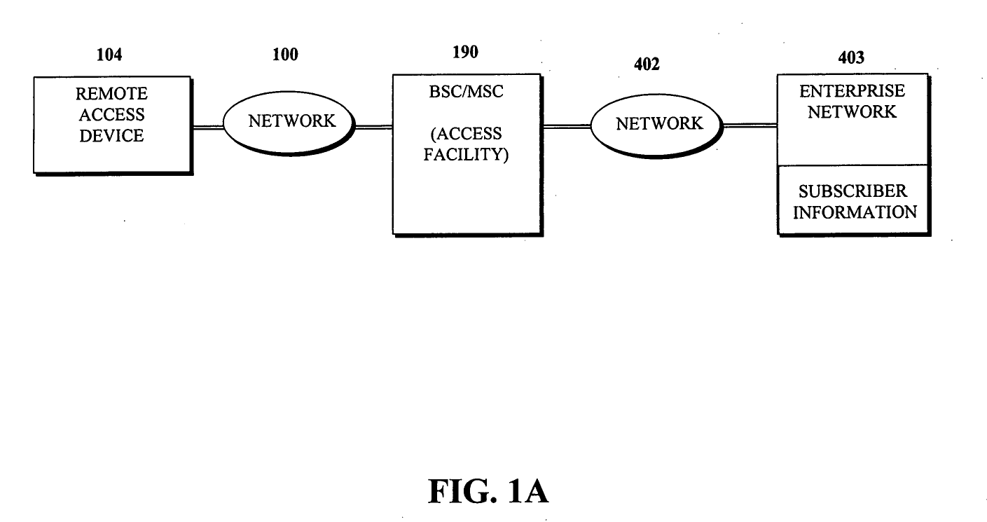

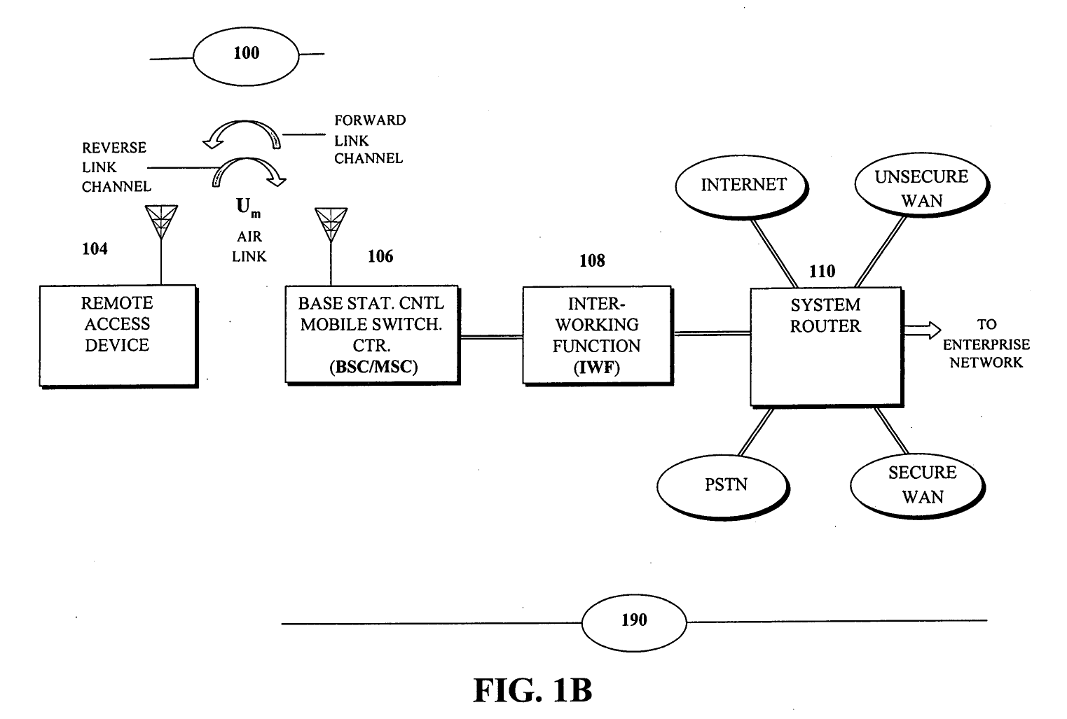

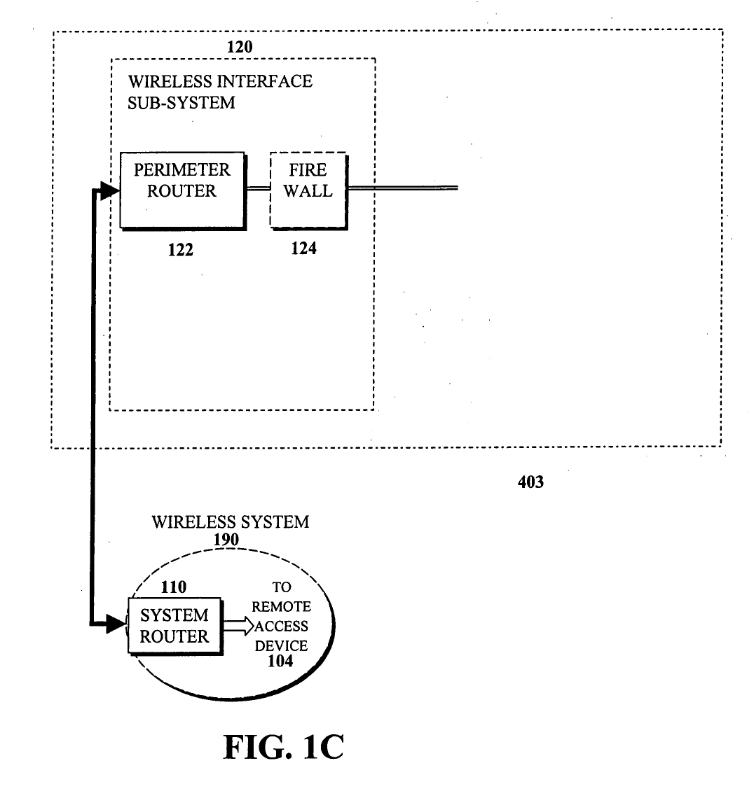

FIG. 1 presents a conceptual overview of the design of the current system. From FIG. 1, a subscriber has access to an input device, which may be one from a class of input devices 10 including, but not limited to, a cellular telephone 11, a personal digital assistant (PDA) 12, a Microsoft® Windows CE device 13, a desktop personal computer 14, or a laptop personal computer 15. Other devices may be employed, such as a two-way paging device or palmtop computer, while still within the scope of the present invention. The important characteristic of the class of input devices 10 is that each device must have the ability to receive information.

The input device transmits or receives information over a data link 16, such as a telephone line, dedicated computer connection, satellite connection, cellular telephone network, the Internet, or other data connection. The data link 16 is connected to an access facility 17, such as an Internet service provider, cellular telephone carrier, telephone switching utility, or other data facility having the ability to receive data in particular formats (cellular telephone traffic, Internet traffic, data packets, and so forth) and convert and efficiently transfer that data over the Internet or other data networks. Access facility 17 provides users with access to information or data maintained at an enterprise network 22. Data is transferred from the access facility 17 in Hypertext Transfer Protocol (HTTP) format over a communication link 18, preferably the Internet, to the remote enterprise 22. In practice, other communication means may be employed, such as a telephone network, a PPTP tunnel through the Internet, or other mechanism for efficiently conveying data traffic.

At the remote enterprise 22, an application gateway server 19 receives data in HTTP format and relies on data stored in storage media 20. Storage media 20 is preferably a SQL data storage server, but any type of data storage mechanism which can be rapidly accessed by the application gateway server 19 is acceptable.

In operation, the subscriber must first access the remote enterprise 22 using an access arrangement, such as an account and password verifying his or her identity. The subscriber makes a request into the subscriber device, such as a cellular telephone, to view data, such as his or her e-mail. The access facility 17 receives the request via the data link 16 and passes the request through the communication link 18 and on to the enterprise network 22. The enterprise network 22 processes the request for e-mail on the application gateway server 19 and obtains the necessary data pursuant to the subscriber preferences available from the provided by the storage media 20 in the enterprise network 22. For example, the subscriber is presumed to have established that if he or she desires e-mail through his or her cellular telephone, the information provided should be only the first ten messages, alphabetized by the last name of the sender. In such a situation, the enterprise network 22 obtains the requisite information and transmits the data back through the communication link 18, to the access facility 17, and to the subscriber via data link 16 to the requesting subscriber input device. To accomplish this, the enterprise network 22 must include a dedicated server 21 having a scalable, reliable and secure data access platform, such as Microsoft® Exchange Server, for ready access to the requested e-mail, calendar, or contact information.

FIG. 1A illustrates an embodiment of the present invention. The embodiment allows subscribers to securely and remotely access information residing in an independent enterprise network 403 in real time. In one implementation, a subscriber, by virtue of a remote access device 104, makes a request, across a network 100, to access facility or Base Station Controller/Mobile Switching Center (BSC/MSC) 106, to supply subscriber information (e.g., messaging and collaboration information, such as electronic mail, appointment calendars, address/phone books). Access facility or Base Station Controller/Mobile Switching Center (BSC/MSC) 106 passes the subscriber information in the form of Internet data packets over network 402 to enterprise network 403. The enterprise network 403 retrieves the subscriber information and formats the information in accordance with the display capabilities of the remote access device 104. The remote access device 104 may be connected to a “wireline” network (e.g., personal computer, kiosk, etc.) or may be connected to a wireless network (e.g., cellular phones, personal digital assistants (PDAs), Microsoft® Windows CE devices, etc.).

The features and details of the various embodiments of the invention will be described below.

1. Remote Access Devices

The remote access and retrieval of subscriber information resident in the enterprise network 403 is initiated by requesting the information on a remote access device 104. Generally, these requests are initiated by inputting an address on a browser (or micro-browser) interface of the remote access device 104. The address partially identifies the enterprise network 403 that the subscriber is associated with (i.e., company, employer, etc.) and the address may be in the form of an HTTP URL (Hypertext Transfer Protocol Uniform Resource Locator). The request may be in other structured formats, including but not limited to XML encoded requests. The remote access devices 104 have communication capabilities, allowing them to interface with wireless and wireline communication networks. In one implementation, the remote access devices 104 are wireless and include devices that are well-known in the art, such as hand-held wireless phones, Personal Digital Assistants (PDAs), Microsoft® Windows CE devices, and mobile computers. Such devices operate in wireless networks that include, but are not limited to PSTN, CDPD, CDMA/IS-95, TDMA/IS-136, MOBITEX, and GSM networks. Each of these devices has a browser associated therewith.

In addition, these remote access devices 104 generally have graphical displays to accommodate their browsing capabilities. The remote access devices may use different markup languages to interpret, format, and display the contents of the retrieved subscriber information. Such languages may include Hypertext Markup Language (HTML), Handheld Device Markup Language (HDML), Extensible Markup Language (XML), Extensible Stylesheet Language (XSL), and Wireless Application Protocol (WAP) Wireless Markup Language (WML).

2. Network Access

As stated above, the remote access devices 104 have communication capabilities to interface with a variety of communication networks including wireless communication systems. FIG. 1B illustrates the basic elements of a wireless implementation of network 100 in FIG. 1A. Artisans of ordinary skill will readily appreciate that these elements, and their interfaces, may be modified, augmented, or subjected to various standards known in the art, without limiting their scope or function.

In one implementation, the remote access device 104 first communicates and sustains a session with a Base Station Controller/Mobile Switching Center (BSC/MSC) 106 via the wireless interface (i.e., air-link) Uₘ in accordance with a wireless communication network scheme, such as CDPD, CDMA/IS-95, TDMA/IS-136, MOBITEX, and GSM. The BSC/MSC 106 employs a transceiver to transmit to the remote access device 104 (i.e., forward link) and receive from the remote access device 104 (i.e., reverse link), consistent with the wireless network scheme. The BSC/MSC 106 supervises, manages, and routes the calls between the remote access device 104 and the Inter-Working Function (IWF) 108.

The IWF 108 serves as a gateway between the wireless system 100 and other networks. The IWF 108 is coupled to the BSC/MSC 106 and in many cases it may be co-located with the BSC/MSC 106. The IWF 108 provides the session data between the remote access device 104 and the BSC/MSC 106 with an IP address, consistent with the well-known Internet Protocol (IP).

As is well-known in the art, the Internet Protocol is a network layer protocol that specifies the addressing and routing of packets (datagrams) between host computers and specifies the encapsulation of data into such packets for transmission. Addressing and routing information is affixed in the header of the packet. IP headers contain 32-bit addresses that identify the sending and receiving hosts. These addresses are used by intermediate routers to select a path through the network for the packet towards its ultimate destination at the intended address. Providing the session between the remote access device 104 and the BSC/MSC 106 with an IP address, the session can be intelligently routed to other networks.

The IWF 108 is subsequently coupled to a system router 110, which interfaces with other networks, such as the Public Switched Telephone Network (PSTN) and other Wide Area Networks (WANs) providing Internet- or secure/unsecure Intranet-based access.

3. Remote Enterprise Network Configuration

Enterprise network 403 remotely and securely collects, processes, and formats the information residing therein and presents the information on the remote access device 104 in real time. Generally, the desired information will be stored in a specialized database/messaging server within the enterprise network 403, such as, for example, Microsoft® Exchange Server 5.5. As shown in FIG. 1C, the enterprise network 403 includes an interface network 120. The interface network 120 employs perimeter router 122 to interface with the wireless communication system 100, which transports the IP datagrams between the remote access device 104 and the BSC/MSC 106. The interface is achieved by virtue of a WAN topology and may employ well-known Asynchronous Transfer Mode (ATM), Frame Relay, dedicated DS-1 (1.544 Mbps), DS-3 (45 Mbps) and other topologies. The perimeter router 122 may connect to the enterprise network 403 through a firewall 124 to provide an added level of protection and further limit access to enterprise network 403 from the Internet. Artisans of ordinary skill will readily appreciate that generally, firewalls are well-known security mechanisms that protect the resources of a private network from users of other networks, and further implementations of firewalls will be described below. For example, enterprises that allow subscribers to access the Internet may install a firewall (or firewalls) to prevent outsiders from accessing its own private data resources and for controlling what outside resources its own subscribers have access to. Basically, firewalls filter incoming and outgoing network packets to determine whether to forward them toward their destination. The firewall 124 interfaces with the gateway server 415.

Application gateway servers 415 are preferably implemented as servers that act as an intermediary between messaging/data servers 410 and Base Station Controller/Mobile Switching Center (BSC/MSC) 106. Application gateway servers 415 provide a layer of abstraction between the messaging/data servers and the Base Station Controller/Mobile Switching Center (BSC/MSC) 106 that enables more efficient communication when communicating over a “slow” network such as the Internet. Application gateway servers 415 are described in more detail below.

If network 402 is a public network, such as the Internet, data transmitted over network 402 is at risk of being intercepted or monitored by third parties. To avoid this problem, the data may be encrypted at its transmission site (e.g., Base Station Controller/Mobile Switching Center (BSC/MSC) 106 or enterprise network 403), and correspondingly decrypted at its reception site. By encrypting all data transmitted over network 402, Base Station Controller/Mobile Switching Center (BSC/MSC) 106, and enterprise network 403 effectively communicate with one another as if they were on a private network. This type of encrypted network communication is called a virtual private network (“VPN”).

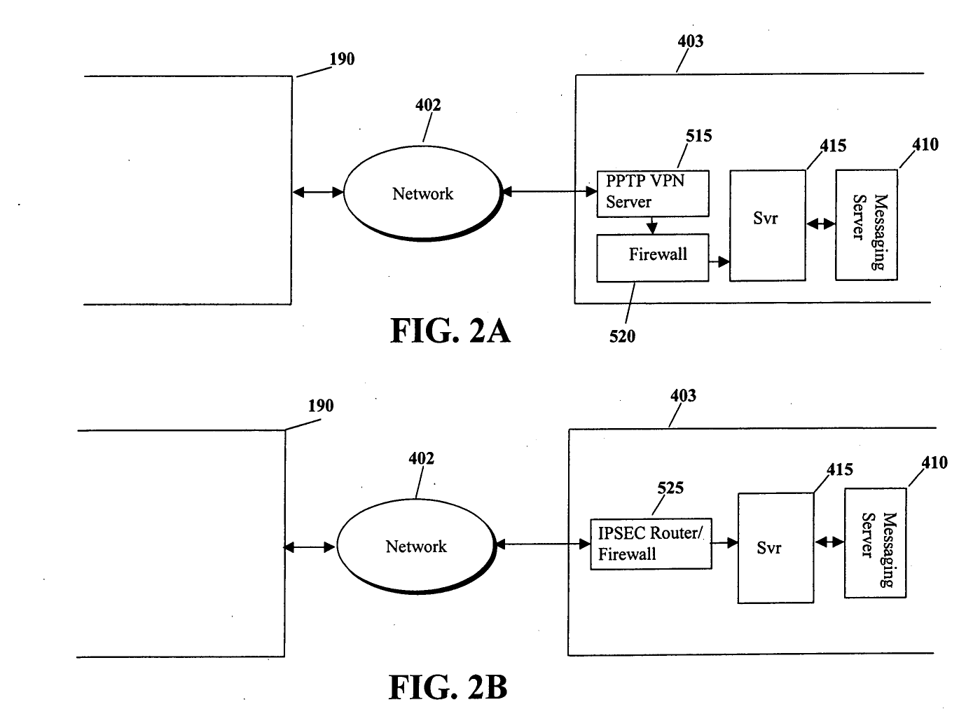

FIGS. 2A and 2B are block diagrams illustrating embodiments of the implementation of a VPN between Base Station Controller/Mobile Switching Center (BSC/MSC) 190 and enterprise network 403. The VPN is implemented by encrypting information transmitted between Base Station Controller/Mobile Switching Center (BSC/MSC) 106 and enterprise gateway server 415 on enterprise network server 403.

As shown in the embodiment of FIG. 2A, Base Station Controller/Mobile Switching Center (BSC/MSC) 106 encrypts the transmitted data using software 510 running thereon. The encrypted data is transmitted over network 402 and decrypted by dedicated VPN server 515. Data flowing from enterprise network 403 to Base Station Controller/Mobile Switching Center (BSC/MSC) 106 is similarly encrypted at VPN server 515 and decrypted by software 510. Firewall 520 may optionally be implemented in conjunction with VPN server 515 to limit unauthorized outsiders from accessing the private data resources of enterprise network 403 and to control what outside resources users at enterprise 403 have access to.

One example of appropriate encryption/decryption software 510 is software that implements the well-known Point-to-Point Tunneling Protocol (PPTP). Although PPTP software 510 is shown executing on a VPN server 515, it may alternatively be implemented in special purpose PPTP routers or other network devices.

FIG. 2B illustrates another embodiment implementing a VPN between Base Station Controller/Mobile Switching Center (BSC/MSC) 106 and enterprise network 403. This embodiment is similar to the one described with reference to FIG. 2A, the primary difference being that the IPSEC (Internet Protocol Security) standard is used to encrypt/decrypt data instead of the PPTP standard. As shown, encryption using IPSEC is implemented by a pair of complementary routers 525.

The IPSEC standard is known in the art. In contrast to the PPTP standard, the IPSEC standard can provide encryption at the session layer or the network packet processing layer. PPTP provides encryption at the session layer. Additionally, the IPSEC standard offers considerably more options in the implementation of bulk encryption and hash algorithms.

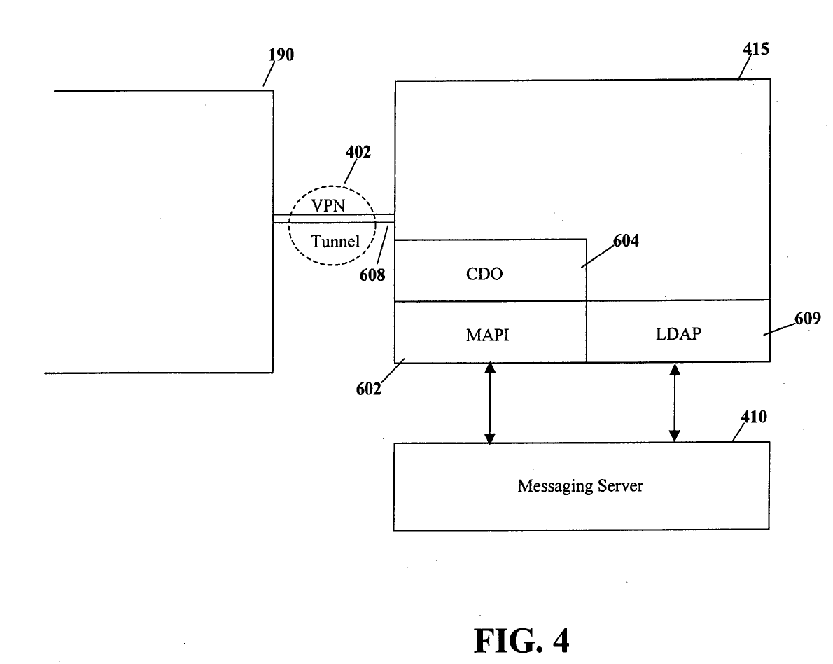

FIG. 4 illustrates an alternate implementation of the interface between the access facility and the enterprise network. As shown in FIG. 4, application gateway server 415 provides a MAPI (Messaging Application Programming Interface) interface 602. MAPI 602 is a Microsoft® Windows program interface that enables software objects on application gateway server 415 to communicate with a MAPI-compliant information store, such as Microsoft® Exchange messaging server 410. MAPI 602 provides the low level interface between application gateway server 415 and messaging server 410. MAPI 602 accesses messaging server 410 based on commands from CDO (Collaboration Data Objects) object 604. CDO 604 is an object in the COM (Component Object Model) framework for the development of component software objects. COM provides the underlying services of interface negotiation, life cycle management (determining when an object can be removed from a system), licensing, and event services (putting one object into service as the result of an event that has happened to another object). MAPI, the COM framework, and the CDO object are all available from Microsoft® Corporation.

CDO 604, in operation, processes requests from data center 190 to access messaging server 410. Typical CDO requests include requests such as: retrieve the message object for a particular email of a particular subscriber, retrieve the subject of the email, and retrieve the time the email was sent. For each of these requests, CDO 604 accesses messaging server 410, retrieves the requested information, and returns the information to the requesting entity.

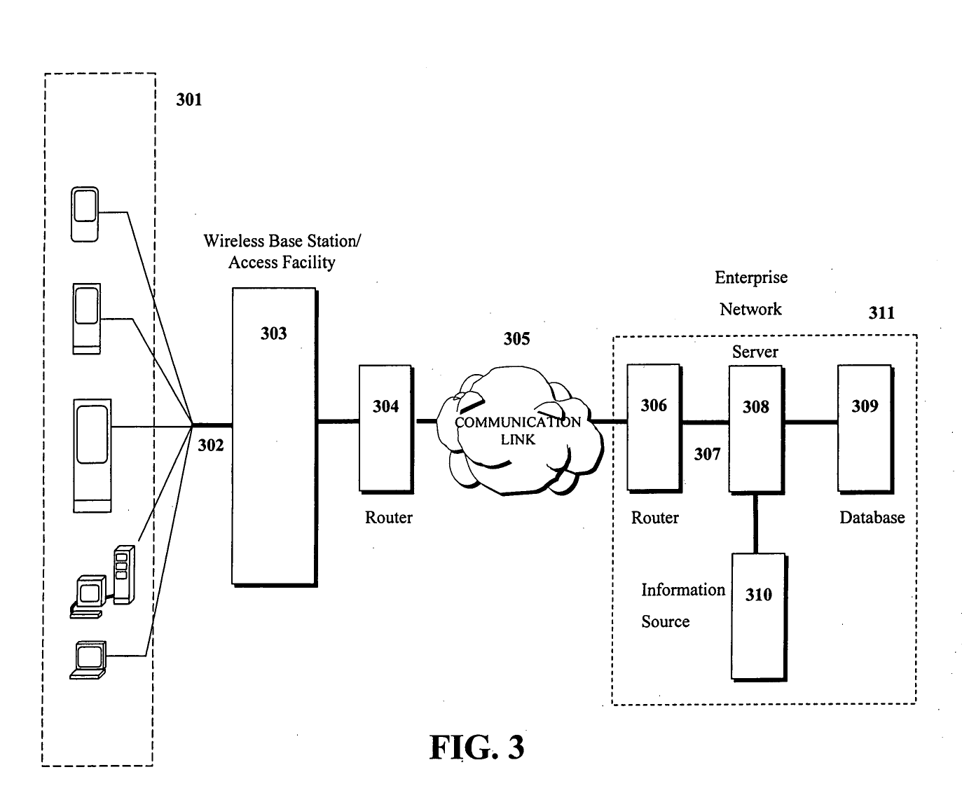

A further simplified version of the system is provided in FIG. 3. From FIG. 3, data is transmitted from the device 301 over the airwaves 302 to a Base Station 303. Base station 303 uses a router 304 to provide data in the form of information packets over a connection 305, such as the Internet, to the enterprise network 311. Enterprise network 311 includes router 306, router connection 307, enterprise gateway server 308, database 309, and information source 310. Router 306 initially receives the request from the device 301 in the form of a URL and transmits the request to dedicated server 308 using router connection 307.

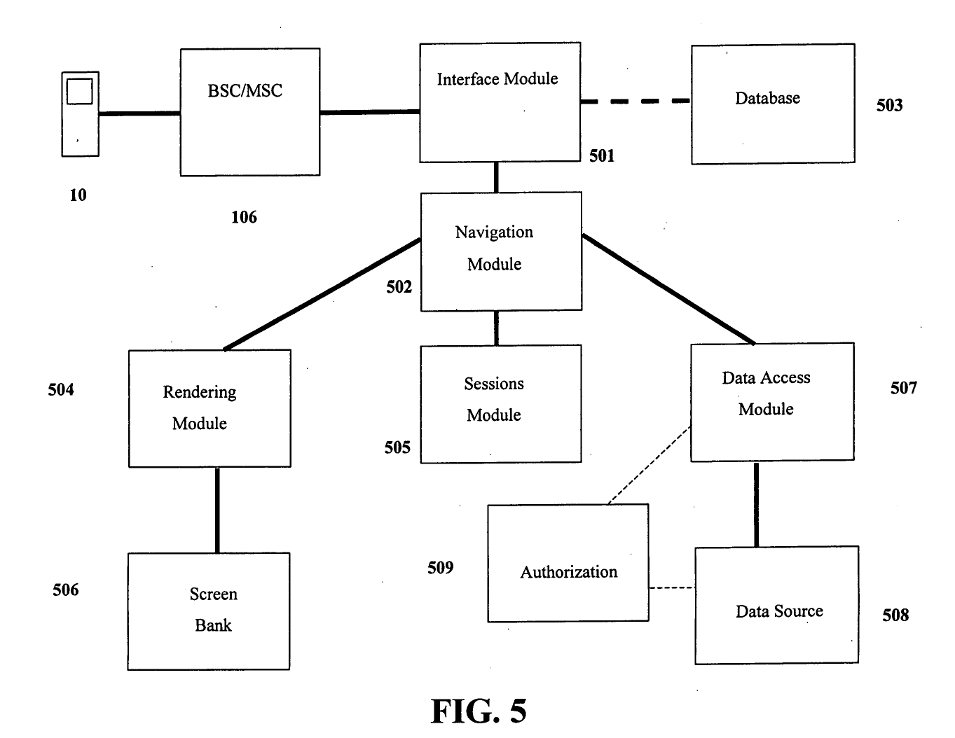

Application gateway server 307 and application gateway server 415 operate according to the mechanization depicted in FIG. 5. According to FIG. 5, the information from Base Station Controller/Mobile Switching Center (BSC/MSC) 106 is transmitted as a URL request for information in the form of a session identifier, page identifier, an action, and additional information. This URL information is received by an interface module 501 in an World Wide Web server employing ISAPI (Internet Server Application Program Interface). ISAPI is an Application Program Interface for Microsoft's IIS (Internet Information Server) Web server. ISAPI enables Web-based applications that run much faster than conventional CGI programs due to tight integration with the Web server. ISAPI is the first segment encountered by the browser request. Interface module 501 represents a software interface and can be an interface other than ISAPI, such as Active Server Pages (ASP) or Device Mobility Interconnect (DMI), or any software having the ability to perform a software routing function and convert a URL into a method call. The method call indicates the type of request made by the browser, the user was on a particular screen, the user initiated a particular action, or other similar information. In an ISAPI configuration, several Web servers from companies other than Microsoft provide support. The interface module 501 passes the action to the navigation module 502, which is a state engine that effectively controls operation of the retrieval and transmission of information at the enterprise server 403. Navigation module 502 interacts with session module 505, which contains local variables, such as the temporary storage of addressee of an email, priority, subject, body, and so forth during the composition of an email across multiple URL requests. Once entered by the user at the device and transmitted to the application gateway server 415 and navigation module 502, each individual variable and the value associated therewith is stored in the sessions module 505. At any one time, sessions module 505 may include, for example, temporary variable ADDRESEE, with associated data TOM SMITH, temporary variable PRIORITY with associated data NORMAL, and so forth. All temporary variables are stored in the session module 505 and may be changed by the user. Once the user has completed the e-mail or other browser function, all variables are collected and transmitted. Once the navigation module 502 parses the URL for session id, page id, and an action, the navigation module 502 acts within the framework depicted in FIG. 5 to use the current browser state and verb, seek and compile the requisite information, and respond with the next logical sequence, such as the next page, next action, or next item in sequence. The temporary variables and data associated therewith held in sessions module 505 is static, such that a user logging out or disconnecting in the middle of a session will cause all data in the sessions module 505 associated with that user session to be lost. The same user initiating a new session will begin with no data associated within session module 505.

Navigation module 502 receives URL data and transmits web page data. The navigation module 502 does not depend on the type of browser or type of device being used by the user. Rather, navigation module 502 merely receives URL data, acts accordingly by assembling the appropriate response to the URL action request, and returns browser appropriate data. Render or rendering module 504 provides the necessary browser specific information to the navigation module 502 for transmission back to the particular device.

Once a page id is known or recognized by the navigation module, an action indicates the page to where the user wishes to go. For example, if a user is entering contact information on screen 8510 (arbitrary screen ID for illustrating this example), completes entering contact data, and wishes to return to the contact page by pressing “enter” or “complete” or some other such transition verb, the navigation module reads the page id (8510) and the action desired (complete entry) and knows that the action associated with “complete” is to transition to screen 8503. Page 8503 is appropriate for the necessary browser used by the particular device. For any particular data needed to render the browser appropriate screen, the render module 504 obtains screen data from screen database 506 and passes that data to navigation module 502. Screen specific data may include a title, graphics, and other information, while user data may include, for example, telephone numbers, addresses, priority levels, and so forth. The user can scroll through the screen, select or otherwise act on the user data or screen data presented, and make a request. User specific data is a data repository that can be refilled. Screen data, such as the title of screen 8510, is implemented so as to be configurable by the user or the enterprise.

The navigation module 502 passes the screen type through to the render module 505 such that it can be used repeatedly, while passing through user data, such as headers for emails, as well as user data or user parameters, such as eight user specific e-mail headers, and thus tells the rendering module 504 what to place in certain locations within the browser page. Navigation module 502 therefore hands off the request for a particular screen, email headers, title inbox, and so forth, to the rendering module 504, which locates the appropriate screen in the screen bank 506 and locates the necessary template, fills the template with the data provided by the navigation module 502, and passes the completed screen to the navigation module. Rendering module 504 may hold hundreds of screens, including several screen 8510s for the various types of user devices available. Rendering module 502 determines the type of browser being used by reading the header associated with the URL received and determines whether the device is a Netscape browser (if the word “mozilla” appears in the header), a Windows CE device if a Windows CE browser, and so forth. Once the type of device has been identified, that information is passed to render to retrieve and compile the appropriate information for transmission.

Data access module 507, also known as information access or data source module, fetches and provides the requested user data. When a user initiates a session and requests access to her mailbox, the navigation module, after authenticating the user, sends a request to data access module 507 to enter the user's mailbox. Data access module 507 interacts with Exchange Server to initiate an active session. Navigate module 502 recognizes from the incoming URL that it must obtain mailbox information and thus queries data access module 507 for the particular information sought, such as the first twenty emails, the first five contacts, or other data. Data is transmitted in XML format, which is an abstract format, from the data access module 507 to navigation module 502. The data access module interfaces with the data source 508, which is a Microsoft® Exchange Server holding all necessary mail, contact, and user data, including passwords. The interface between data access module 507 and data source 508 enables obtaining and transmission of the necessary information. Reports back from the render module 505 or data access module 504 are subsequently compiled and transmitted to the user. In the event of an error, the navigation module 502 transmits an error screen or message back to the user indicating an error has occurred. Other objects besides mail capability include contact management systems, sales force automation systems, customer management systems, Oracle or other database front ends. In these cases, servers other than Microsoft® Exchange Server are accessed by the data access module 507.

For purposes of authentication, the user initially enters a name and password, which passes to the navigation module and on to the data source, to authentication module 509. The authentication module 509 queries the data source 508, which keeps track of permissible users on the system. Under the implementation illustrated, a user may enter with a username but cannot obtain information from the data source 508 without a password. Authentication module 509 compares the entered password to the passwords stored on the data source 508 and, if correct, retrieves the requested data and passes the requested data to the navigation module 502. Thus passwords are stored with data. The authentication module can be username and password, but other authentication methods may be used to verify a user, including but not limited to retina scans, fingerprint verification, pass cards, and so forth. Data retrieved by these authentication methods is then compared against data maintained in data source 508 and data passed only when verification is achieved.

Navigation module 502 obtains information such as username and identification information from database 503, which is typically a SQL database. The database 503 only holds username data and not password data. This permits user access to the system based on entry of an acceptable username. The enterprise network 403 performs the authentication outlined above. Once the user has been authenticated, navigation module 502 evaluates the URL by parsing the information and making the call for necessary data. Once the navigation module has compiled the requisite information from the session module, rendering module, and data access module, the browser specific data is sent back through interface module 501 and to the device.

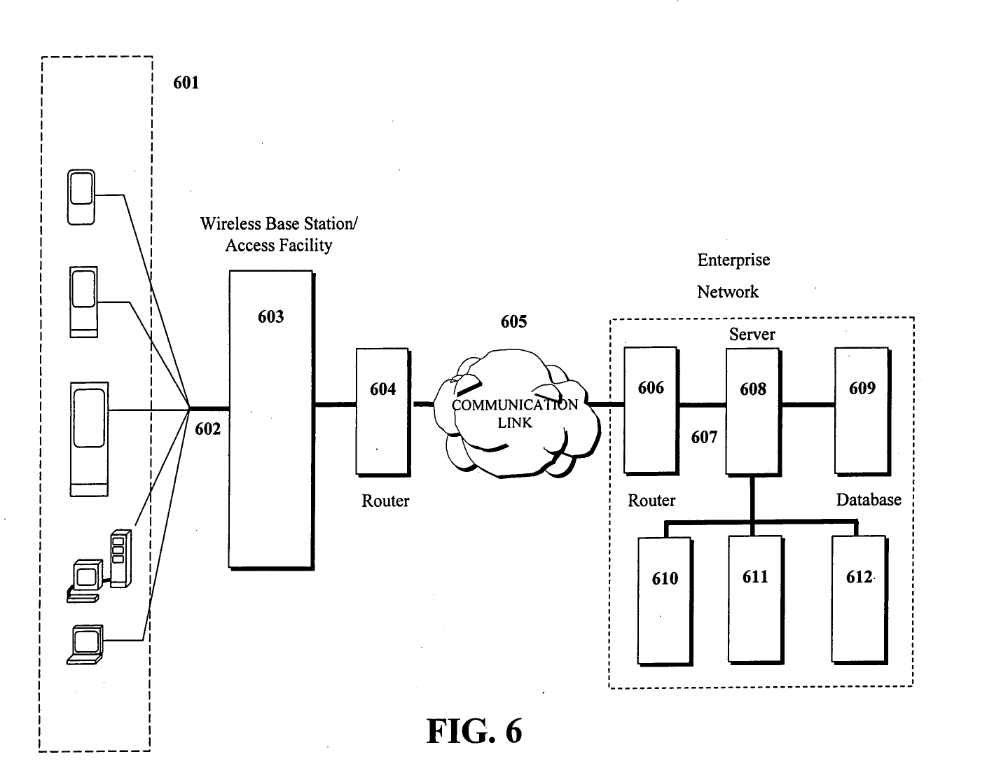

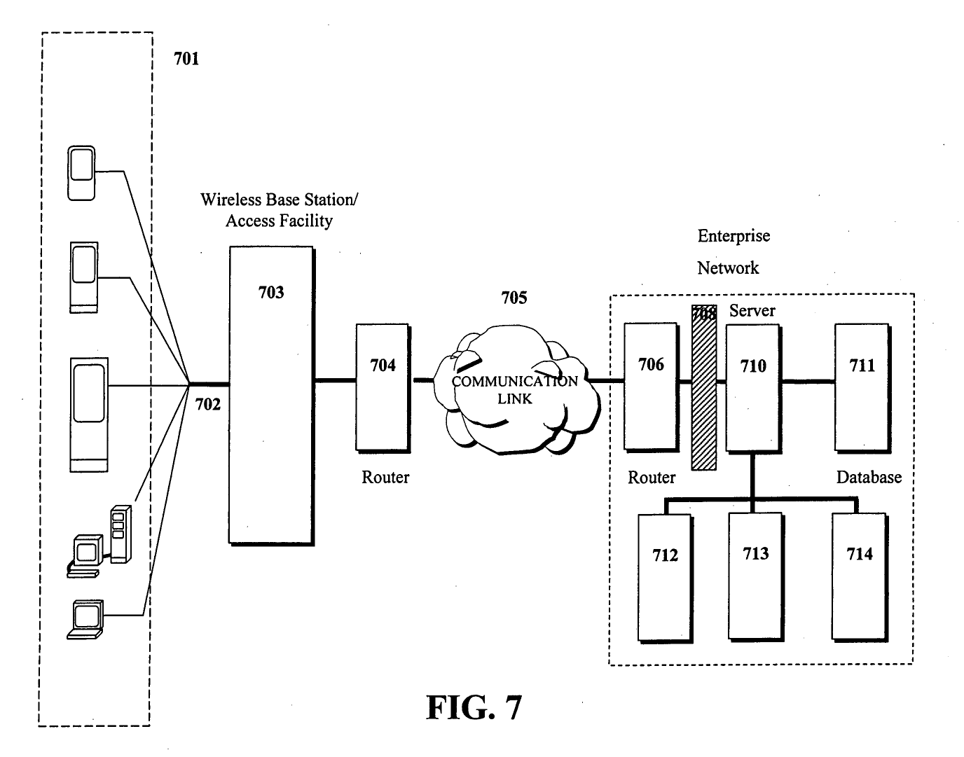

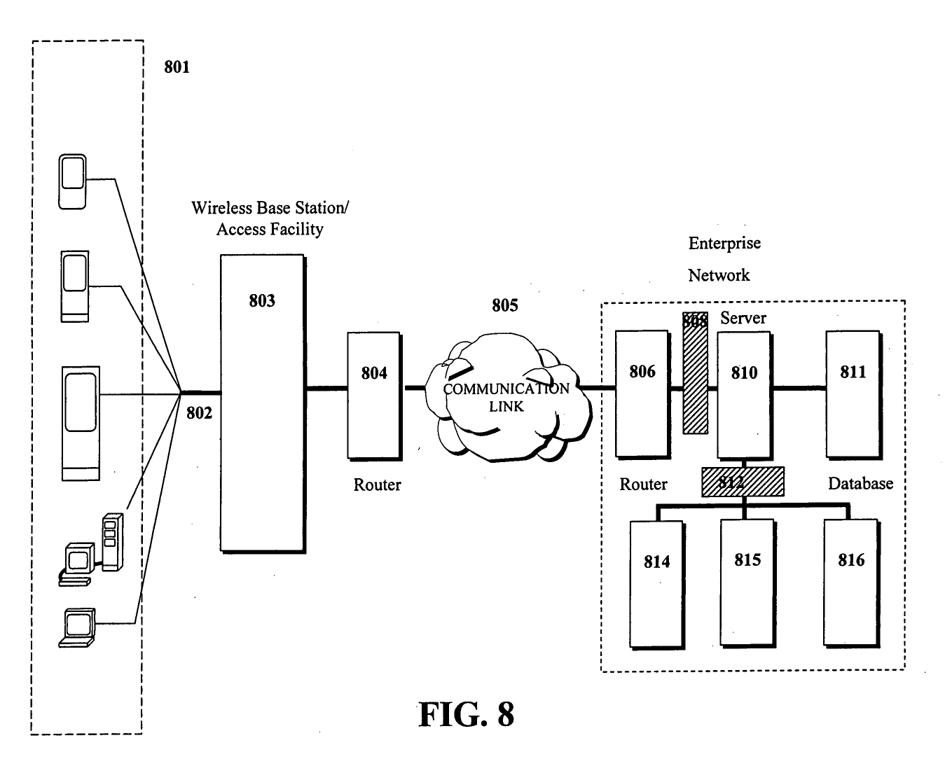

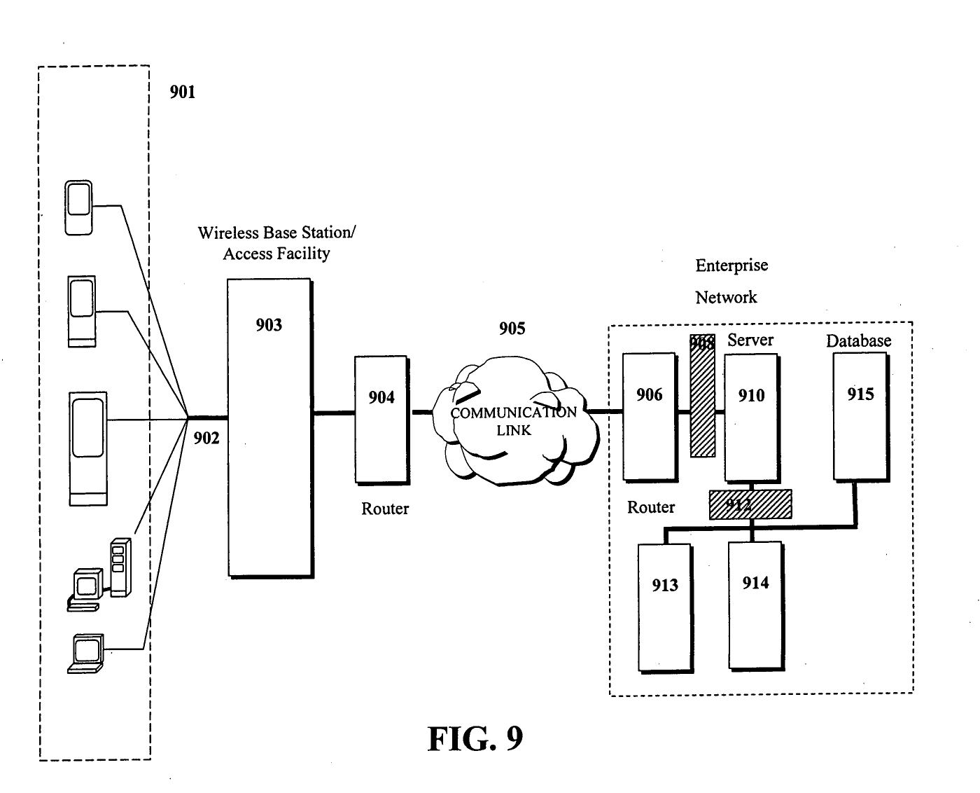

FIG. 6 shows an alternate mechanization employing multiple information sources, where one source 610 contains mailbox data, a second source 611 contact data, and the third source 612 messaging data or other user and enterprise appropriate data. FIG. 7 illustrates the system employing a firewall 708 between router 706 and the application gateway server 710. The firewall 708 prevents unwanted Internet access to the server and remainder of the configuration. FIG. 8 illustrates yet another configuration in accordance with the current invention, including a dual firewall setup (firewall 808 and 812) surrounding application gateway server 710. Use of a dual firewall permits user access to server data while protecting data, such as mailbox, contact, or other user specific data from persons having or desiring access to the enterprise but not having the appropriate need or credentials to access alternate information. In FIG. 8, database 811 permits user verification according to username and entry into the enterprise, which may be useful for an enterprise wishing to permit customer access to certain information but employee access to all information. FIG. 9 illustrates an alternate configuration employing the database 915 behind both firewalls, such that users are permitted access to the application gateway server 910 without a username or other information, but must use the database to access any mailbox, contact, or other user specific data.

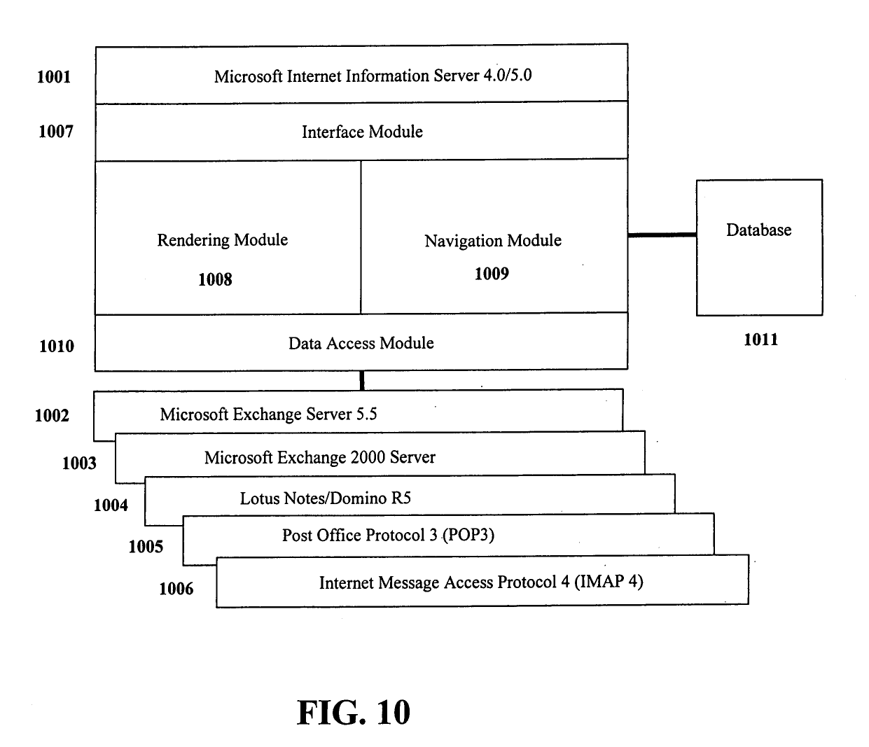

FIG. 10 is a hardware specific implementation of the current system, using an IIS Server 1001 as a front end, with data access module accessing a Microsoft Exchange Server Version 5.5 1002, Microsoft Exchange 2000 Server 1003, Lotus Notes/Domino R5 1004, POP3 Server 1005, or IMAP4 Server 1006. Other similar hardware may be employed while still within the scope of the current invention.

A further aspect of the current system is the ability for the system to determine the type of device accessing the system. For example, the system receives information over a data line including initialization information, account information, passwords, and so forth, in addition to browser information. Browser information includes the information requested for the type of browser used, e.g. a Microsoft® Windows CE device indicates that it is using a Windows CE compliant browser. Included in the browser information is header information from which the enterprise network 403 can determine the type of device transmitting the data The enterprise network 403 stores the information expected to be received from a particular browser; for example, the Netscape browser, used on desktop and laptop devices, may include the word “mozilla” in its header information. The enterprise network 403 maintains predetermined expected header parameters for each anticipated input device. This predetermined information is preferably maintained in the SQL server. Upon connection between the input device and the enterprise network, the data center retrieves the browser header information and compares this information with the predetermined information and, if it determines a match, interfaces with the input device with input device specific data, e.g. screen size limitations, colors/greyscale data, and so forth. Thus the system does not require user input to determine the type of device addressing the enterprise network 415 and can transmit appropriate input device specific data to the user.

The foregoing description of preferred embodiments of the present invention provides illustration and description, but is not intended to be exhaustive or to limit the invention to the precise form disclosed. Modifications and variations are possible consistent with the above teachings or may be acquired from practice of the invention. Accordingly, the scope of the invention is defined by the claims and their equivalents.

What is claimed:

1. A system for remotely accessing subscriber information from an enterprise network in real-time, the system comprising:
a data network;
a remote access device coupled to the data network, the remote device having browser capabilities to accommodate a request inputted by a subscriber to access the subscriber information;
an application gateway server hosting the subscriber information, the application gateway server comprising:
a navigation module for receiving data in a predetermined format and accessing device specific information;
a session module for maintaining temporary data associated with the subscriber, said session module interfacing with said navigation module;
a rendering module for obtaining the requisite browser data based on desired action and current state;
a data source module for obtaining subscriber information and passing said subscriber information to the navigation module; and
an authentication module associated with said data source module for verifying subscriber credentials.

2. The system of claim 1, further comprising a database associated with said data source module, wherein said authentication module compares user data with user stored data, said user stored data being stored on said database.

3. The system of claim 1, wherein said data in a predetermined format comprises data in URL format.

4. The system of claim 1, wherein said subscriber information comprises at least one from the group comprising:
mailbox information;
calendar information;
contact information; and
enterprise specific information.

5. The system of claim 1, wherein:
said navigation module extracts an action request from said data in the predetermined format, passes the action request to the data source module which retrieves any necessary information based upon the action request; and
said navigation module retrieves a browser specific screen corresponding to the action request from the rendering module.

6. The system of claim 1, wherein the data network has the ability to receive information and data requests in remote access device specific formats and convert said information and data requests into data packets.

7. The system of claim 1, wherein the data network comprises the Internet.

8. The system of claim 1, wherein the data network comprises a dedicated network connection.

9. The system of claim 1, wherein the remote access device comprises at least one from a group including:
a personal computer;
a laptop computer;
a palmtop computer;
a personal digital assistant;
a cellular telephone;
a two-way pager; and
a Microsoft® Windows CE device.

10. A method for accessing subscriber information, comprising the steps of:
receiving a subscriber information request in a predetermined format;
navigating the access and transmission of the requested subscriber information, said transmission of the requested subscriber information being in a subscriber device specific predetermined format, said access and transmission navigating step comprising:
compiling subscriber information based on said subscriber information request;
assembling and rendering said subscriber information into a device specific format, said device specific format depending on said subscriber device; and
transmitting the assembled and rendered subscriber information to said subscriber device;
wherein said predetermined format for said subscriber information request differs from said subscriber device specific predetermined format.

11. The method of claim 10, wherein said predetermined format comprises URL format and the subscriber device specific format comprises a browser format compatible with the device used by the subscriber.

12. The method of claim 10, further comprising the step of:
parsing said subscriber information into an action task and a page specific task, said parsing step occurring prior to said compiling step.

13. The method of claim 10, further comprising the step of:
verifying user credentials using credential verification information maintained with subscriber information at a local database.

14. The method of claim 10, wherein said subscriber information comprises at least one from the group comprising:
contact information;
calendar information;
mailbox information;
paging information; and
enterprise specific information.

15. The method of claim 10, wherein said subscriber information compiling step comprises seeking requested information from a local database.

16. The method of claim 10, wherein the subscriber device comprises at least one from a group including:
a personal computer;
a laptop computer;
a palmtop computer;
a personal digital assistant;
a cellular telephone;
a two-way pager; and
a Microsoft® Windows CE device.

17. An application gateway server for accessing subscriber information, said application gateway server comprising:
a navigation module for receiving a subscriber information request in a first predetermined format, obtaining requested information, and transmitting the requested information to said subscriber in a second predetermined format;
a data access module for accessing data requested by the navigation module, the data access module accessing subscriber data maintained on an enterprise database;
a rendering module for obtaining device specific formats associated with the data accessed by said data access module and providing device specific formats to the navigation module; and
a session module for maintaining intermediate data required to perform the navigation module functions.

18. The application gateway server of claim 17, further comprising an authentication module to verify subscriber credentials, said subscriber credentials at least partially residing on said enterprise database.

19. The application gateway server of claim 17, wherein said enterprise network receives subscriber requests in URL format and transmits device specific subscriber data in a browser specific format.

20. The application gateway server of claim 19, wherein said navigation module parses said URL subscriber request into segments, at least one segment comprising a requested action.

21. The application gateway server of claim 19, wherein the device comprises at least one from a group including:
a personal computer;
a laptop computer;
a palmtop computer;
a personal digital assistant;
a cellular telephone;
a two-way pager; and
a Microsoft® Windows CE device.
